(19) United States
(12) Patent Application Publication
(10) Pub. No.: US 2002/0021005 A1
(43) Pub. Date: Feb. 21, 2002

(54) Mechanical blocking mechanism for the reciprocal union of two elements, used particularly for bottling-line equipment

(75) Inventor: Volpi Giovanni, Cesano Boscone (IT)

Correspondence Address: HARRISON & EGBERT, 7th Floor, 412 Main St., Houston, TX, 77002, US

(73) Assignee: HABASIT ITALIANA SPA

(21) Appl. No.: 09/910,353

(22) Filed: Jul. 23, 2001

(30) Foreign Application Priority Data
Aug. 11, 2000 (IT) TV2000A000099

(51) Int. Cl. F16L 27/00

(52) U.S. Cl. 285/145.3; 215/294

(57) ABSTRACT

Mechanical blocking mechanism for the reciprocal union of two elements, for equipment used for the bottling of liquids, made up of respectively: a cylindrical container, which is fixed to the first part to be joined, with one of its ends that protrudes, and which has openings around its perimeter that go through to the outside; a piston located internally and which moves longitudinally with respect to the said cylindrical container, and which has seats around its perimeter into which locking-spheres are partially fitted and which operate in conjunction with the cylindrical container; a spring which counteracts the axial movement of the piston; means for moving the said piston; means, if required, to check on its condition; and in which, in the second part, there is a hole which includes a holding means for the said mechanism, made up of a ring with a continuous groove around its internal perimeter which, under operational conditions, coincides with the perimetral opening formed on the cylindrical container of the mechanism.

### BACKGROUND OF THE INVENTION

1. Field of the Invention

The object of this invention is a mechanical blocking mechanism for the reciprocal union of two elements.

The invention has particular, but not necessarily exclusive, application in the sector involved in the bottling of liquids.

2. Description of the Related Art

Traditional fastening methods and techniques, such as by means of screws in conjunction with fixing nuts, are well known. They are usually used to hold a number of parts or components together, or to keep them at a certain distance from each other.

The main characteristic of this type of arrangement is that it allows the screws to be removed as and when required, in order to replace or substitute one or more of the parts or components previously held together.

Bottling lines are one such example of this type of arrangement. This kind of plant, for example the washing, filling and capping equipment and its relative mechanisms, is extremely complex, and has a series of transportation means that follow a predefined route, used for moving large quantities of containers quickly and continuously one after the other. The said route, apart from the movement means itself, has a series of special lateral guides. An example is given by the so called heart of the equipment, which is usually made up of two or more guides on each side and that, being positioned one above the other, form a guide channel with the ones on the opposite side, and along which the containers are fed, thus preventing them from falling.

Working in conjunction with the said guides, there are either free or driven mechanisms similar to wheels, also known as stars, that are positioned at a given distance from each other in correspondence with joints or with the straight sections, that are used to receive and guide the containers downstream along the line, and help to keep them at a certain distance from each other according to the process to be carried out on them. The said stars are usually made up of one or more discs which may also be lain one on top of the other, with a series of contiguous concave seats similar to the form around the perimeter of the containers.

Finally, the said guides and stars are fixed solidly to the main structure or tower of the plant which, in turn, is fixed solidly to the floor.

The companies involve in this specialised sector have to often change the shape and size of the container according to the type of product to be bottled, and have to change the format a number of times every working day. As a result, in order to guarantee the correct movement and transport along the line, and because each type of container has its own particular size or shape, it is necessary to change the equipment, including the guides and the stars, that is positioned along the route.

The replacement is carried out by hand, with the personnel having to remove the fixing means used for attaching the parts and equipment to the main framework at each anchorage point. It is a very cumbersome and tiring operation, with specialised workers being used for the task, and the amount of time required will be according to the size of the plant. The total of all the down-times required for each substitution obviously means that the plant is at a standstill for that period, which therefore influences on the overall running costs of the plant, sometimes quite heavily.

In order to make the intervention easier for the personnel, and to slightly reduce the amount of time required to replace the equipment, the first idea was to use an alternative to traditional fastening methods and techniques where wrenches or pliers are required. One type of this kind of arrangement used a spacer-pin inserted co-axially into a tubular body, in order to keep the two elements of the guide at a certain distance. The pin, in this case in an upper position, has a kind of grip on one side, while on the other side, on the end that protrudes with respect to the body of the spacer, there is a body similar to a hook made up of an element that passes through it transversally. From an operational viewpoint, in order to assemble the pin together with the support frame, the end of the pin is inserted into a corresponding seat which is positioned in the underlying support frame for the equipment. By acting upon the grip, the pin is rotated in one direction or another so that the element that passes through it pushes against the underlying surface of the said frame that supports the guide, thus holding it in position. In order to release it, the opposite rotating action is obviously required, so that the guides may be removed.

Even in the above described case, the intervention of specialised personnel is required, and even if the job of inserting and removing the equipment from its relative frame on the production line is made easier and quicker, due to the fact that hand-tools are no longer required, it still requires a considerable amount of manual work in order to release each single piece of equipment, by rotating the aforementioned grip. This means that the amount of time required is still high, which means a reduced amount of production capacity for the plant.

With the aim of overcoming the aforementioned problems, some companies have considered using semi-automatic equipment in order to fasten the equipment in position, and some of these ideas are still in a study phase while others are already being tested.

One of these alternative systems in particular consists basically of a cylindrical body, with an element in its upper part which, when rotated in one direction, acts radially upon a series of holding plates. When the mechanism used to attach a guide-piece to the frame of a bottling line is applied, the plates are released peripherally in order to coincide with the upper surface of the guide piece and to hold it in position. If the opposite movement is carried out, the said plates retract inside the cylindrical body, to free the equipment which can then be easily removed.

From a practical point of view, the system has proven to be efficient. However, it is not widely used because it is very complex and requires a lot of maintenance work, and it is difficult for the company that developed the system to market it.

For this reason, the companies that operate especially in the bottling sector require alternative systems that are an improvement on the ones previously proposed.

### BRIEF SUMMARY OF THE INVENTION

These and other objectives are reached through this invention according to the characteristics in the attached claims, overcoming the problems outlined by means of a mechanical blocking mechanism for the reciprocal union of two elements, for production lines and equipment used for the bottling of liquids, made up of respectively:

a cylindrical container, which is fixed to the first part to be joined, with one of its ends that protrudes, and which has openings around its perimeter that go through to the outside;

a piston located internally and co-axially to the cylindrical body, and which moves longitudinally with respect to the said cylindrical container, and which has seats around its perimeter into which locking spheres are partially fitted and which operate in conjunction with the wall of the cylindrical container;

a spring which counteracts the axial movement of the piston with respect to the cylindrical container;

means for moving the said piston;

means, if required, to check on the operating condition of the mechanism;

and in which, in the second part which is to be fixed to the first part, there is a hole which includes a holding means for the said mechanism, made up of a ring with a continuous seat around its internal perimeter which, under operational conditions, coincides with the perimetral openings formed on the cylindrical container of the mechanism inserted co-axially with respect to the said ring.

In this way, through the creative contribution that has the effect of constituting an immediate technical progress, various advantages are achieved.

Firstly, the replacement of the equipment that makes up the bottling line may be carried out much more quickly, especially the replacement of the stars and the special guides, resulting in a considerable reduction of the total down-time of the plant.

The operation of removal and assembly of the equipment, especially for mechanisms that are pre-disposed for the automatic version, do not require any operation to be carried out for each single anchorage point, but there is just a simple unlocking movement that releases all the mechanisms that are interconnected, and which may be only a part of the whole equipment.

In all versions, whether it is the manual version or the automatic version, no particular experience is required by the personnel and the operation may be carried out by anybody and without having to resort to the use of specific tools or equipment.

From a construction point of view, the mechanism is extremely reliable, almost no maintenance operations are required and, by performing only minor modifications, may be adapted for either manual or automatic operation.

Finally, a further advantage regards the fact that the mechanism has been designed to avoid injuries to the workers or damage to the equipment and plant. In fact, they usually remain in the locked position and only by means of human intervention may the perimetral blocking means be released. In this way, if there is a mechanism or equipment that uses compressed air during working operations, the blocking function is guaranteed all the same, even if there is no compressed air.

### BRIEF DESCRIPTION OF THE SEVERAL VIEWS OF THE DRAWINGS

These and other advantages will be shown in the following detailed description and attached schematic drawings of various preferential solutions, the particulars of which are to be considered simply illustrative and not limiting.

FIG. 1 is a side view of a blocking mechanism together with the anchorage plate of the frame.

FIG. 2 is another side view of the blocking mechanism only, as shown in FIG. 1.

FIG. 3 is a sectional view of the mechanism as shown in FIG. 1, along the vertical A-A axis.

FIG. 4 is a transversal sectional view of the mechanism as shown in FIG. 1, along the horizontal B-13 axis.

FIG. 5 is a further sectional view of the mechanism.

FIG. 6 is a sectional view of a holding means, and in particular of a ring that works in conjunction with the blocking mechanism.

FIG. 7 is a three-dimensional view of the blocking mechanism and of its relative holding means.

FIG. 8 is a variation of the mechanism shown in the previous drawings, showing a blocking means which is operated manually.

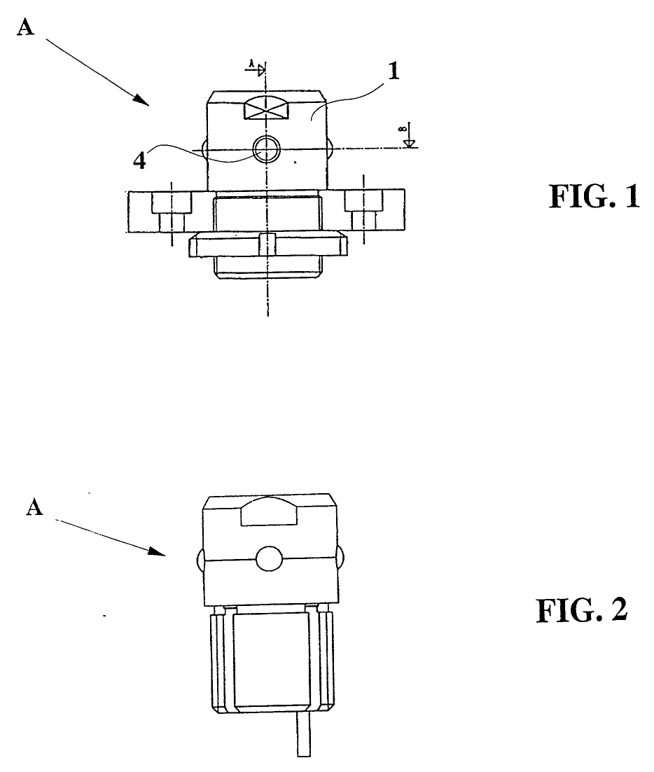

Finally, FIG. 9 is a view of a part of the mechanism, regarding one of the possible uses of the blocking mechanisms.

### DETAILED DESCRIPTION OF THE INVENTION

The invention contained herein regards a manual, automatic or semi-automatic mechanical blocking mechanism used to join and hold the two parts together.

Going into detail, the mechanism (A) is made up firstly by a container or sleeve (1) which is basically cylindrical in shape, obtained by joining two monolithic bodies (11, 12), upper and lower respectively, in a counter-facing position, with each one with a cavity which is part of the chamber obtained inside the sleeve (1) In correspondence with the joint between the two said bodies (11, 12) which form the sleeve (1) and along the wall, there are a number of openings (13), in this case four, which are diametrically opposite to each other, and which pass through to create a contact between the chamber of the sleeve (1) and the outside. The said openings (13) are circular and there function is to allow the blocking means, described more in detail below, to stick out slightly through them, in order to act upon the surfaces which surround and co-operate with the said mechanism (A).

Going further into detail, on the inside of the said sleeve (1), there is a cylindrical piston (2) which moves co-axially, and which has a seat (21) on the top in order to position the end (31) of a helicoidal compression spring (3). In this case the end (32), which is opposite the end (31) for the spring, presses internally against the upper side of the sleeve (1), acting against the piston (2) every time it rises.

The said piston (2) has a continuous, semi-spherical seat (22) around its perimeter, and the position of the seat (22) coincides exactly with the position of the openings (13) when the piston (2) is in an up position. The purpose of the said semi-spherical seat (22) is to partially house the blocking systems, in this case spherical balls (4). Going further into detail, the semi-spherical seat (22) has a guide seat (221) which protrudes on one side, in this case the top side, which is also cut into the vertical wall of the piston (2). In this way, there are two support points available for each spherical blocking ball (4), so that they rest all together either in correspondence with the first semispherical seat (22) or the second one (221).

Regarding the movement of the piston (2), in a first example it is given by the action of a fluid, and in particular air. At the base of the sleeve (1), there is a fitting (5) to which a coupling for the air-line is attached. The said fitting (5) connects the coupling (not shown) to the base (23) of the piston (2), and has a perimetral seal (231). As a result, by blowing in compressed air, the piston (2) rises up, and is controlled and contrasted by the opposite force given by the spring (3).

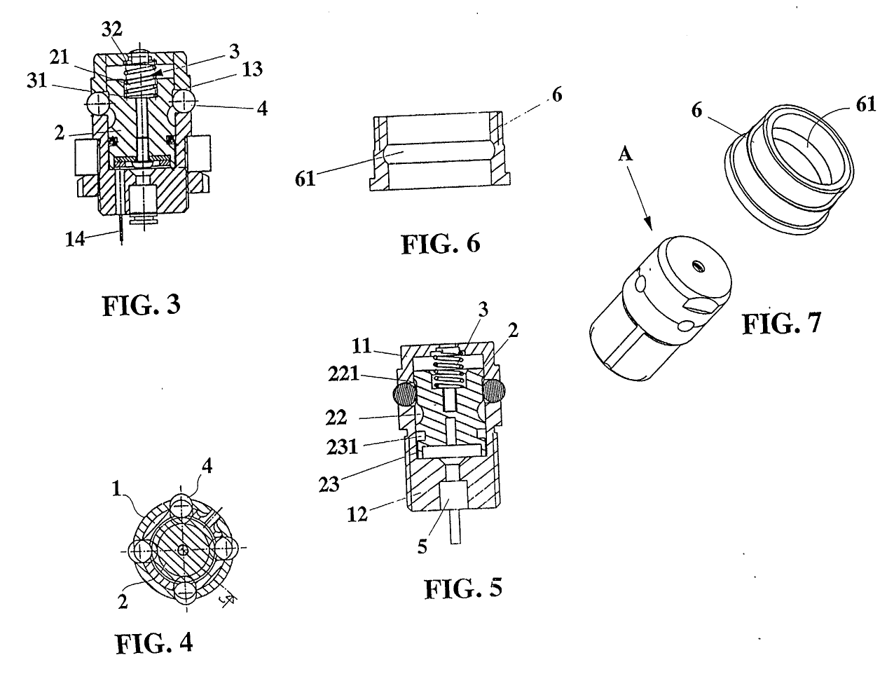

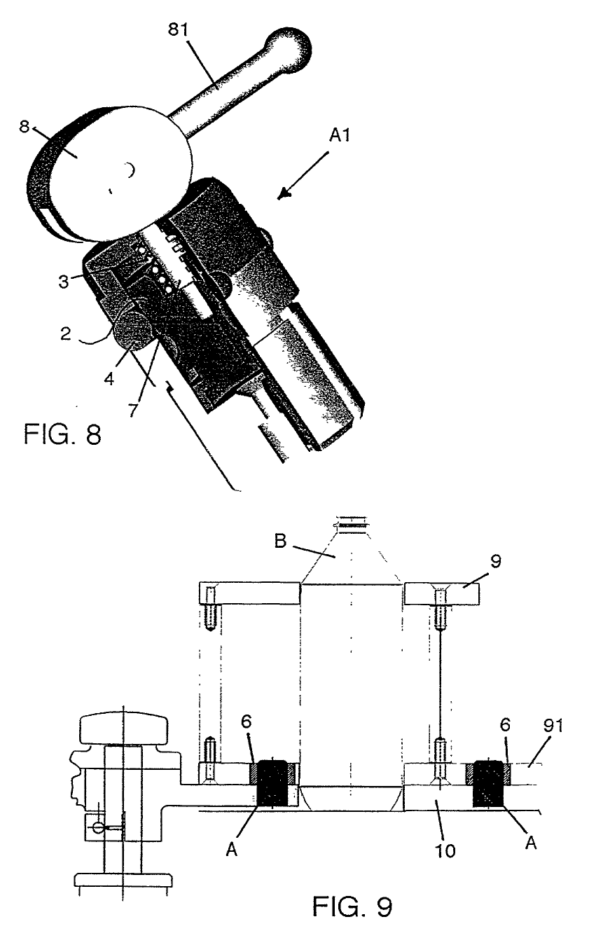

In the position shown in FIG. 3, which corresponds to the expansion phase of the spherical balls (4) and consequent blockage of the mechanism (A), the piston (2) is in a down position, and rests on the bottom of the inside of the sleeve (1), held in position by the spring (3). In this position, the spherical balls (4) protrude slightly and externally from the sleeve (1), since they are positioned inside holes (13), and, because the diameter of the said holes (13) is smaller than the diameter of the spherical balls (4), they interfere with one side of them. Their movement, under these conditions, is blocked because, on the opposite side, the spherical balls (4) press against the guide seat (221) formed along the side of the piston (2).

In the successive position (not shown), and which corresponds with the release phase of the mechanism, the piston (2) is positioned in a lifted position with respect to the bottom of the chamber of the sleeve (1), because of the effect of the input of compressed air into the lower part. In this position, the spherical balls (4) are no longer in a tight condition on the inside, and pass into the semi-spherical seat (22) (see movement shown in FIG. 4). In this case, the spherical balls (4) are held in the perimeter wall of the sleeve (1), so that the mechanism (A) may be pulled out from the holding piece which works in conjunction with it.

The said holding piece may, in one example, be made of a simple ring (6) with a channel (61) formed along its internal perimeter. By making the openings (13) of the sleeve (1) of the mechanism (1) coincide with the channel (61), it is clear how, under operational conditions, there is interference with the protruding portion of the spherical balls (4), thus making it impossible for the ring to be drawn out with respect to the sleeve (1) of the mechanism (A), and which is inserted co-axially.

A further characteristic which helps the aforementioned blocking mechanism (A) is given by the presence of a sensor (114), for example a magnetic type, which detects whether or not the piston (2) is located at the bottom of the sleeve (1), the position which coincides with the locked position of the mechanism.

One possible variation to the pneumatically-operated mechanism (A) described above is made up of a mechanism (A1) which is operated manually.

In this case, the main components are those described in the previous example. The difference lies in the use of a shaft (7) for the movement, which is inserted through the upper body (11) of the sleeve (1) co-axially to the spring (3), and operates on the top surface of the piston (2). In this case, the shaft (7) protrudes from the top of the said sleeve (1) and pivots around a cam (8) with a grip (81) on one side. By acting on the grip (81), a part of the surface of the cam acts upon the top of the said sleeve (1), leading to an axial movement of the shaft (7). Forcing the grip (81) into an axial position with respect to the shaft (7), the piston (2) is pushed into an up position, which lets the spherical balls (4) re-enter.

Another proposal, which is an example of an application as shown in FIG. 9, may require at least two (A)-type blocking mechanisms. Going further into detail, one part of the equipment is made up of pair of guides (9, 91) on each side, with one guide above the other, to hold a movable container (B) in position. The said guides (9, 91) form a single piece, and are joined together beforehand by means of spacer, which is basically a tubular body which is positioned between the upper guide (9) and the lower guide (91). In this case, the lower guide (91) was previously drilled, and, in correspondence with the said hole, a ring (6) with a groove (61) around its internal perimeter to locate the protruding portion of the spherical locking balls (4) was fastened to the guide. Regarding the support frame (10) for the equipment, two inter-connected blockage mechanisms (A) were fastened to the frame (10), one on the guide side and one on the star side. Each mechanism (A) has a part of its sleeve (1) which protrudes from the frame (10), and in particular at least the upper end which has the area with the openings (13) through which the spherical balls (4) protrude. Because the position of the rings (6) located on the lower guide (91) of the equipment coincide with the position of the mechanisms (A) fastened to the frame (10), in order to join the two parts it is necessary to simply make the ring-holes (6) coincide with portion that sticks out from each mechanism (A), making sure that they are inserted on the inside. It is clear that, during the procedure for joining the various parts of the plant, each mechanism (A) must be placed under pressure in order to keep the piston (2) in a lifted position so that the spherical balls (4) no longer rest inside the ring (6). Once the assembly is completed, by removing the pressure the piston (2) will be forced to return to the lower position by the action of the spring (3), acting upon the spherical balls (4) and forcing them to pass through the wall of the sleeve (1) and press on the channel (61) of the ring (6), thus blocking and holding the mechanism.

In order to release the mechanism (A), the opposite movement is simply required.

1. Mechanical blocking mechanism for the reciprocal joining of two parts, characterised by the fact that it includes:
a sleeve (1), which is fixed to the first part to be joined, with one of its ends that protrudes, and which has at least one opening (23) around its perimeter that goes through to the outside;
a piston (2) located internally and co-axially to the said sleeve (1) which moves longitudinally with respect to the said cylindrical container, and which has at least one seat (22, 22 1) around its perimeter into which a locking piece (4) is partially fitted and which operates in conjunction with the wall of the sleeve (1);
a means (3) which counteracts the axial movement of the piston (2) with respect to the container (1);
means (5, 7-8-81) for moving the said piston (2).

2. Mechanical blocking mechanism for the reciprocal joining of two parts according to claim 1, characterised by the fact that, working in conjunction with the mechanism (A), there is a holding means (6) located in the second piece which is to be joined to the first piece and which, along its internal perimeter, has at least one seat which, with the mechanism (A) in a working position, 20 coincides with the perimetral opening (13) formed on the container (1) of the mechanism.

3. Mechanical blocking mechanism for the reciprocal joining of two parts according to claims 1 and 2, characterised by the fact that it has a means (14) which detects the presence of the piston (2) which is close to at least one of the two ends of the chamber of a sleeve (1).

4. Mechanical blocking mechanism for the reciprocal joining of two parts according to the previous claims, characterised by the fact that, along the wall of the cylindrical sleeve (1), which is divided into two parts (11, 12), a series of openings (13) are formed, and which connect the chamber of the sleeve (1) to the outside; the said openings (13) have a circular conformation.

5. Mechanical blocking mechanism for the reciprocal joining of two parts according to the previous claims, characterised by the fact that on the inside of the sleeve (1), there is a cylindrical piston (2) which moves coaxially, and which has a seat (21) on the top in order to position the end (31) of a helicoidal compression spring (3), while the opposite end (3 2) presses internally against the upper side of the sleeve (1).

6. Mechanical blocking mechanism for the reciprocal joining of two parts according to the previous claims, characterised by the fact that the piston (2) has at least one continuous, semispherical seat (22) around its perimeter, and the position of the seat (22), when the piston (2) is in an up position, coincides exactly with the position of the openings (113) positioned around the perimeter of the sleeve (1).formed on the. The purpose of the said semi-spherical seat (22) is to partially house the blocking systems, in this case spherical balls (4). Going further into detail, the semi-spherical seat (22) has a guide seat (221) which protrudes on one side, in this case the top side, which is also cut into the vertical wall of the piston (2). In this way, there are two support points available for each spherical blockage ball (4), so that they rest all together either in correspondence with the first semi-spherical seat (22) or the second one (221).

7. Mechanical blocking mechanism for the reciprocal joining of two parts according to the previous claims, characterised by the fact that, in the piston (2), the semi-spherical seat (22) works in conjunction with at least one guide seat (221) which protrudes from one side, and which is cut into the vertical wall of the piston (2).

8. Mechanical blocking mechanism for the reciprocal joining of two parts according to the previous claims, characterised by the fact that the blocking pieces are made up of spherical balls (4).

9. Mechanical blocking mechanism for the reciprocal joining of two parts according to the previous claims, characterised by the fact that, on the bottom of the chamber of the sleeve (1) there is a fitting (5) to which the coupling for the compressed air inlet is attached.

10. Mechanical blocking mechanism for the reciprocal joining of two parts according to the claims 1 to 8, characterised by the fact that there is a shaft (7) which is inserted through the upper body (11) of the sleeve (1) co-axially to the spring (3), and operates on the top surface of the piston (2); and in which, the said shaft (7) protrudes from the top of the said sleeve (1) and pivots around a cam (8) with a grip (81) on one side.

11. Mechanical blocking mechanism for the reciprocal joining of two parts according to the previous claims, characterised by the fact that the body (6) that works in conjunction for holding with the mechanism (A), is made up of a ring (6), with a channel (61) formed along its internal perimeter, and that under operating conditions coincides with the openings (13) in the sleeve (1) of the mechanism (A), and houses the protruding portion of the spherical balls (4).

12. Equipment, used particularly on production lines for the bottling of liquids, made up of at least one guide (9, 91) on each side, in order to hold a movable container (B) in position, and in which the lower guide (91) was previously drilled, characterised by the fact that, in correspondence with each hole in the lower guide (91), there is a ring (6) with a groove (61) around its internal perimeter to locate the protruding portion of the spherical locking balls (4), while the support frame (10) for the equipment has inter-connected blocking mechanisms (A) fastened to it, on the guide side and on the star side respectively, with at least the upper part of each one protruding from the frame (10), and which has area with the openings (13) through which the spherical balls (4) protrude.

13. Equipment, used particularly on production lines for the bottling of liquids according to the previous claim, characterised by the fact that the position of the rings (6) located on the lower guide (91) of the equipment coincide with the position of the mechanisms (A) fastened to the frame (10).
